(19) United States
(12) Patent Application Publication
(10) Pub. No.: US 2020/0006024 A1
(43) Pub. Date: Jan. 2, 2020

(54) Switch Self-Actuation Mitigation Using A Tracking Signal

(71) Applicant: Menlo Microsystems, Inc., Irvine, CA (US)

(72) Inventor: Doug Hawk, Mission Viejo, CA (US)

(21) Appl. No.: 16/451,686

(22) Filed: Jun. 25, 2019

Related U.S. Application Data
(60) Provisional application No. 62/691,232, filed on Jun. 28, 2018.

(51) Int. Cl. H01H 47/00; H01H 59/00

(52) U.S. Cl. CPC H01H 47/001; H01H 2239/03; H01H 59/0009

(57) ABSTRACT

A method of mitigating self-actuation of a switch may comprise generating a tracking signal, based on an input signal that the switch is configured to convey, and combining the tracking signal with an actuating signal to generate a modified actuating signal. The actuating signal may be configured to change a state of the switch from a first state (e.g., ON) to a second state (e.g., OFF). The method further comprises selectively applying the modified actuating signal to a gate of the switch. A switch self-actuation mitigation system may comprise a first coupling device for electrically couple an AC component of a first signal to a node, where the first signal is applied a switch input. The system may further comprise a second coupling device configured to electrically couple an actuating signal to the node, and a driving device configured to selectively couple the node to a gate of the switch.

### RELATED APPLICATION

This application claims the benefit of U.S. Provisional Application No. 62/691,232, filed on Jun. 28, 2018. The entire teachings of the above application are incorporated herein by reference.

### BACKGROUND

A micro-electro-mechanical system (MEMS) switch 100, an example of which is shown in FIGS. 1A and 1B, operates on the principle of electrostatic force, to provide actuation of a cantilevered beam 102 (i.e., a mechanically movable element) to a contact 104, which in turn provides a connection between the input 106 and output 108 of the switch 100. The magnitude of the electrostatic force may depend on various factors, for example beam material composition.

FIG. 1A shows the switch 100 in the open (or off) state, in which the bump 110 of the beam 102 is not electrically connected to the contact 104, so a signal cannot pass from the input 106 to the output 108. In the off state, zero volts is applied to the gate 112 of the switch 100, with respect to the voltage of the beam 102, so little or no electrostatic force is applied to the beam 102.

FIG. 1B shows the switch 100 in the closed (or on) state, in which the bump 110 of the beam 102 is electrically coupled to the contact 104, so a signal can pass from the input 106 to the output 108. In the on state, an activation voltage (75 volts in this example) is applied to the gate 112, with respect to the voltage of the beam 102, causing an activation electrostatic force to be applied to the beam 102. The electrostatic force causes the beam 102 to flex downward toward the gate 112, which in turn causes the bump 108 to be electrically coupled to the contact 104.

Since the electrostatic force is dependent on the gate-to-beam delta voltage (V_{gate}-V_{beam}), MEMS switches are sensitive to any effective alteration of the voltage between the gate 112 and beam 102 of the switch 100. An alternating current (AC) signal with a large amplitude, for example an RF signal, can alter the V_{gate}-V_{beam} delta voltage, such that an unintended result may occur. Under such conditions, the switch 100 may be initially on, and de-actuate unintentionally. Similarly, the switch 100 may be initially off, and actuate unintentionally. Both unintended events are a result of the signal propagating through the switch 100, causing a change in the electrostatic force to be either less than the mechanical restoring force of a beam in the closed state or greater that the beam mechanical restoring force in the open state. Unintentionally changing the state of the switch while a signal is being actively conducted by the switch is referred to as “hot switching.” Hot switching, especially if it occurs often, may have a significant effect on the life and reliability of the switch due to contact erosion and heating of the switch.

FIG. 1C illustrates a prior art switch system configuration. A MEMS switch 120 is connected between a signal source 122 and a signal destination 124. A switch driver 126, which is typically a power field effect transistor (FET), provides an actuation signal 128 to the gate 130 of the switch 120. The signal source 122 generates a signal 132 to propagate through the switch 120 to the signal destination 124.

A voltage source 134 generates a raw actuation signal 136 with a voltage sufficient to actuate the switch 120. A switch controller 138 provides an actuating signal 140 to the driver 126, which selectively couples the raw actuation signal 136 to the gate 130 of the switch 120 as the actuation signal 128. When the switch controller 138 causes raw actuation signal 136 to be coupled to the switch gate 130 through the driver, the switch is actuated to its closed (i.e., on) state.

### SUMMARY

The described embodiments may comprise a switch self-actuation mitigation system based on a generated tracking signal. The system may utilize a high-impedance and low parasitic coupling configuration of the RF input signal to generate a corrective tracking signal. The tracking signal may be applied to the switch gate, in-phase with the signal on the switch beam, to reduce or eliminate the variation on the V_{gate}-V_{beam} delta voltage that causes undesired excursions below the pull-out voltage V_{PO} of the switch in its closed state, or excursions above the pull-in voltage of the switch in its open state.

In one aspect, the invention may be an apparatus for mitigating self-actuation of a switch, comprising an input port of the switch configured to receive a radio frequency input signal, an actuator configured to selectively apply an actuating voltage to the switch, thereby causing a state of the switch to change from one of non-conductive to conductive or conductive to non-conductive, a coupler configured to couple at least a portion of the input signal to the actuating voltage, and an output port that is electrically coupled to the input port when the state of the switch is conductive. The switch may further comprise an output port, a mechanically movable element (e.g., a beam) configured to selectively couple the input port to the output port, and a gate configured to facilitate application of the actuating force to the mechanically movable element.

The coupler may comprise a capacitor having a first terminal and a second terminal, the first terminal electrically coupled to the input port and the second terminal electrically coupled to the gate. The radio frequency input signal may be characterized by a minimum frequency that is larger than a resonant frequency of the mechanically movable element.

The actuator may be configured to apply the actuating voltage to the switch through a resistor. A first terminal of the resistor may be electrically coupled to the actuator, and a second terminal of the resistor may be electrically coupled to a node. The node may be further electrically coupled to the gate, such that the coupler conveys at least a portion of the input signal to the node

The actuator may comprise an actuating voltage source, a driver, a switch controller, a first resistor and a second resistor. The actuating voltage source may be electrically coupled to a node through the first resistor, a first port of the driver may be coupled to the node, and a second port of the driver may be electrically coupled to a reference potential (e.g., ground). A control port of the driver may be electrically coupled to the switch controller, and the node may be electrically coupled to the gate through the second resistor. The driver may selectively couple the first port of the driver to the second port of the driver in response to a switch control signal from the switch controller, which is applied to the control port of the driver.

The mechanically movable element may comprise two or more movable segments, each of which is configured to selectively couple the input port to a respective output port.

The switch may comprise a first switch segment comprising a first output port, a first mechanically movable element configured to selectively electrically couple the first input port to the first output port, and a first gate configured to facilitate application of the actuating force to the first mechanically movable element. The switch may further comprise a second switch segment comprising a second output port, a second mechanically movable element configured to selectively electrically couple the second input port to the second output port, and a second gate configured to facilitate application of the actuating force to the second mechanically movable element. The first gate may be electrically coupled to the second gate, the first output port may be electrically coupled to the second input port.

The coupler may comprise a capacitor having a first terminal and a second terminal. The first terminal may be electrically coupled to the first output port and the second input port, and the second terminal may be electrically coupled to the first gate and the second gate.

The actuator may comprise an actuating voltage source, a driver, a switch controller, a first resistor and a second resistor. The actuating voltage source may be electrically coupled to a node through the first resistor, a first port of the driver may be electrically coupled to the node through a second resistor, the first port of the driver may be coupled to the gate, and the coupler may couple the input signal to the node. A control port of the driver may be electrically coupled to the switch controller, and the driver may selectively couple the first port of the driver to the second port of the driver in response to a switch control signal from the switch controller applied to the control port of the driver. The coupler may further comprise a filter, which may be a low pass filter. In other embodiments, the filter may be a band pass filter.

In another aspect, the invention may be a method of mitigating self-actuation of a switch. The method may comprise coupling an input signal from a signal source to an input port of the switch, and combining at least a portion of the input signal with a switch actuating voltage, thereby forming a tracking signal configured to facilitate a switch actuation force.

The switch may further comprise (i) a mechanically movable element (i.e., a beam) configured to selectively couple the input port of the switch to an output port of the switch, and (ii) a gate configured to apply an actuating force to the mechanically movable element. Combining at least a portion of the input signal with the switch actuating voltage may further comprise at least partially coupling the input signal to the gate. At least partially coupling the input signal to the gate may further comprise disposing a capacitor between the input port of the switch and the gate. The method may further comprise applying, by an actuator, an actuating voltage to the gate. Applying an actuating voltage to the gate may further comprise selectively coupling a node to a reference potential in response to a switch control signal. The node may be electrically coupled to the gate through a first resistor, and be electrically coupled to an actuating voltage source through a second resistor.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A and 1B show an example of a prior art micro-electro-mechanical system (MEMS) switch.

FIG. 1C shows a prior art MEMS switch system configuration.

FIG. 2A shows an example embodiment of a tracking signal-based switch self-actuation mitigation system according to the invention.

FIG. 2B shows another example embodiment of the tracking signal-based switch self-actuation mitigation system shown in FIG. 2A.

FIG. 2C illustrates an example embodiment of the tracking signal-based switch self-actuation mitigation system used in association with a series-connected pair of MEMS switches, according to the invention.

FIG. 3 shows an example of signal levels associated with the beam and contacts of a MEMS switch.

FIG. 4 shows MEMS switch transmission signals biased by an applied gate voltage.

FIG. 5 shows the transmission signals shown in FIG. 4 at higher amplitudes.

FIG. 6A shows the transmission signals shown in FIG. 5 mitigated by at least one the embodiments described herein.

FIG. 6B shows a more detailed view of the mitigated transmission signals shown in FIG. 6A.

FIGS. 7-9 show alternative example embodiments of a switch self-actuation mitigation system according to the invention.

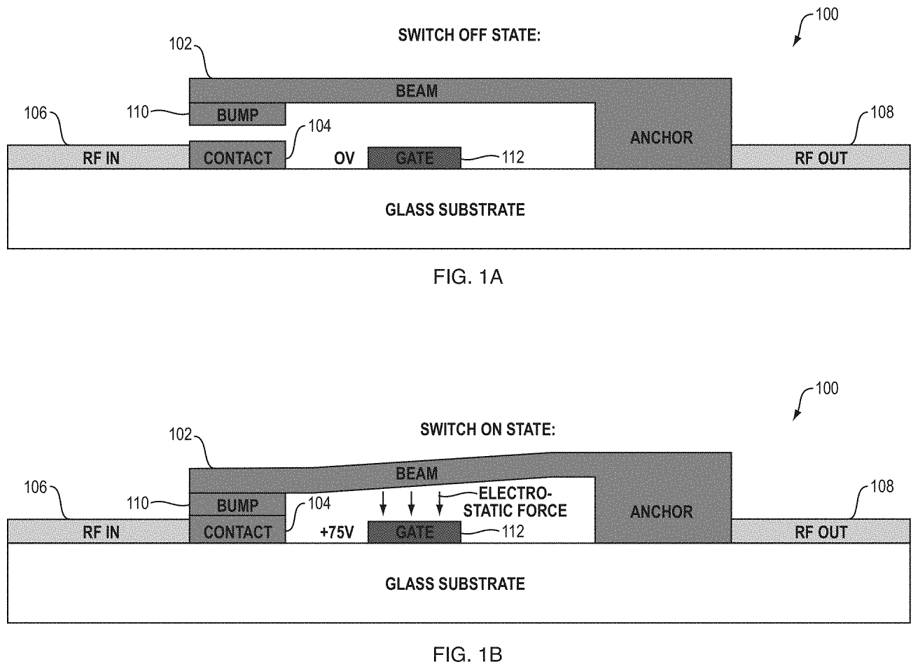

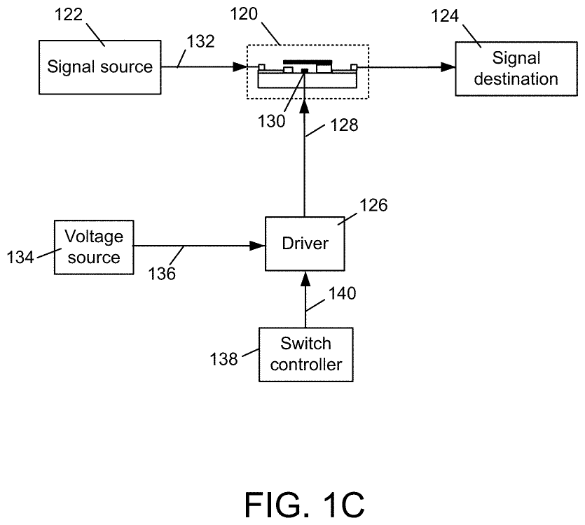

### DETAILED DESCRIPTION

A description of example embodiments follows.

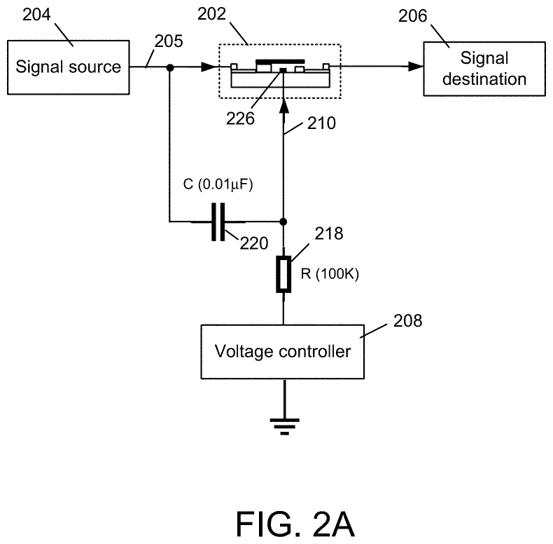

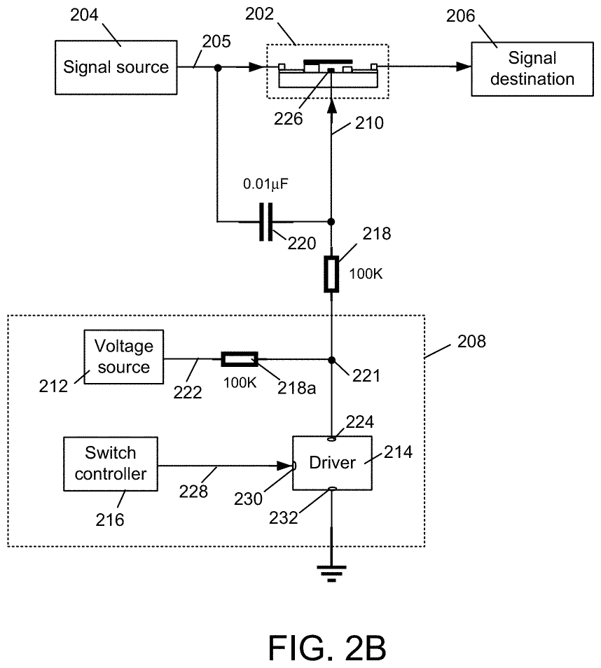

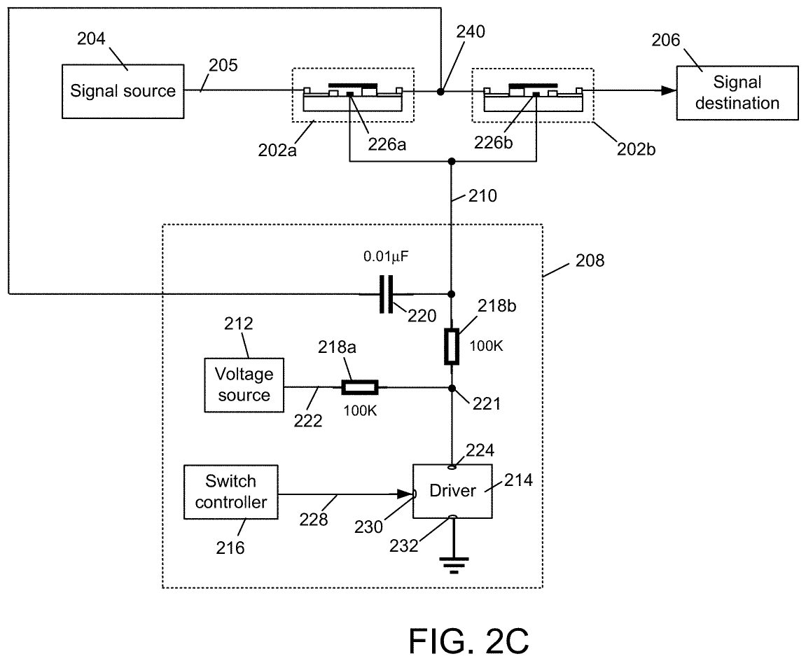

FIG. 2A illustrates an example embodiment of a tracking signal-based switch self-actuation mitigation system according to the invention. A MEMS switch 202, as described herein, is connected between a signal source 204 and a signal destination 206. A voltage controller 208 (also referred to herein as an actuator) causes an actuation signal 210 to be applied to the MEMS switch 202 through a resistor 218. The signal source 204 generates a signal 205 to selectively propagate through the switch 202 to the signal destination 206, as a function of the actuation signal 210. At least a portion of the signal 205 is coupled to the MEMS switch 202, combined with the actuation signal 210. In the example embodiment, the resistor 218 has a value of 100K ohms, and the capacitor 220 has a value of 0.01 μF, although these values are only examples and are not intended to be limiting.

FIG. 2B illustrates an example embodiment of the tracking signal-based switch self-actuation mitigation system shown in FIG. 2A, with an example implementation of the voltage controller 208. FIG. 2B depicts an example implementation for the purposes of explanation, and is not intended to be limiting.

The voltage controller 208 comprises a voltage source 212, a driver 214, a switch controller 216, a resistor 218, a second resistor 218a, and a capacitor 220. The voltage source 212 generates a raw actuation signal 222 with a voltage sufficient to actuate the switch 202. The raw actuation voltage signal 222 is coupled to a first port the second resistor 218a. The second port of the second resistor 218a is coupled to a node 221 that couples a first port of the resistor 218 to a driver port 224. The second port of the resistor 218 is coupled to the gate 226 of the switch 202 and to a first port of the capacitor 220. The second port of the capacitor 220 is coupled to the connection between the signal source 204 and the switch 202, which conveys the signal 205.

The switch controller 216 provides a switch control signal 228 to a control input 230 of the driver. The switch control signal 228 causes the driver 214 to selectively couple the port 224 of the driver to port 232 of the driver. The port 232 of the driver is connected to a reference potential (e.g., ground potential). The switch control signal therefore selectively connects and disconnects node 221 to ground.

When the driver connects node 221 to ground, the gate 226 of the switch is effectively tied to ground. When the driver disconnects node 221 from ground, the gate 226 of the switch is effectively at the voltage of the raw actuation voltage signal 222, plus the signal 205 coupled by the capacitor 220. In the example embodiment, the resistors 218 and 218a each have a value of 100K ohms, and the capacitor 220 has a value of 0.01 μF, although these values are only examples and are not intended to be limiting.

The capacitor 220 couples the signal 205 to the actuation signal 226, so that the signal 205 is AC coupled, in-phase, to the actuation signal 210, thereby combining AC components of the output of the signal source with the raw actuation signal 222 and forming a tracking signal. The capacitor 220 further prevents the direct current (DC) actuation voltage from affecting the signal 205.

Certain applications using a MEMS switch may require a switch with a single input and two or more outputs. The described embodiments may be used to mitigate self-actuation of a switch having such multiple outputs. FIG. 2C illustrates an example embodiment of the invention used in association with a series-connected pair of MEMS switches 202a, 202b. The switches are series connected so that the beams of the switches are coupled at the series connection 240. In this configuration, the series connection 240 is coupled to the second port of the capacitor 220, and the actuation signal 210 drives the gates 226a and 226b simultaneously.

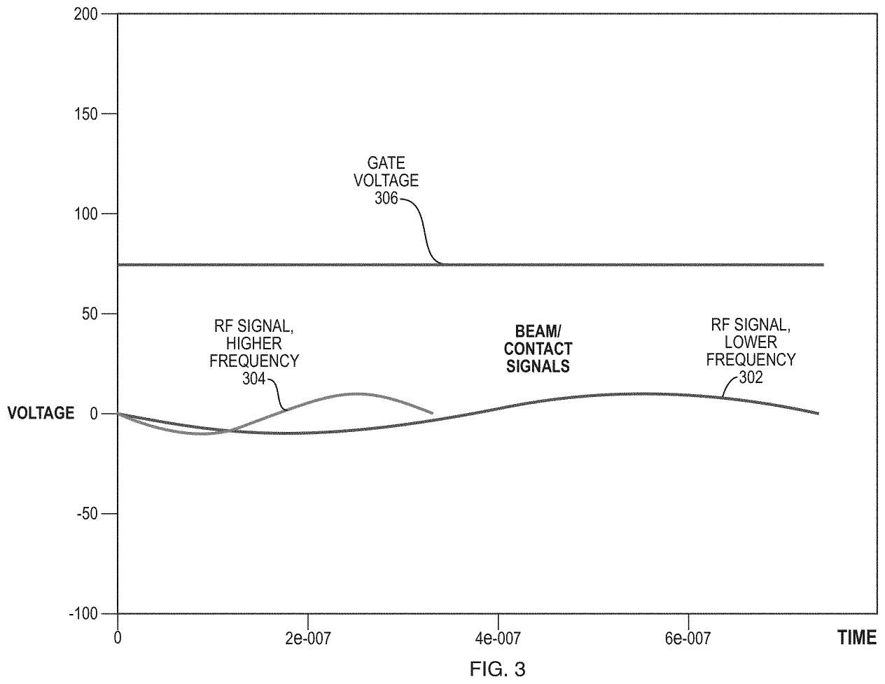

FIG. 3 illustrates an example of signal levels associated with the beam and contacts of a MEMS switch, for an input signal at relatively low levels. FIG. 3 shows two example signals, one signal 302 at a relatively low frequency, another signal 304 at a higher frequency, and both approximately 20V peak to peak (p-p), along with a gate voltage signal 306 of approximately 75V. When the MEMS gate voltage is substantially higher than the peak to peak continuous wave voltage, the high frequency voltage is not great enough to disrupt and cause the MEMS switch to unintentionally open.

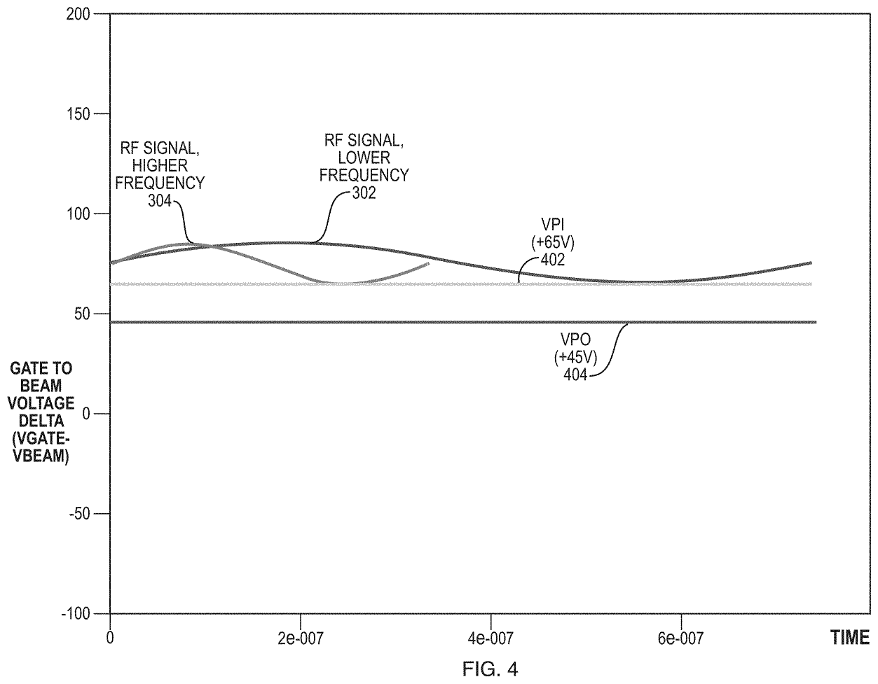

FIG. 4 shows the two signals 302, 304 biased by the gate voltage, with respect to the gate of the switch (i.e., V_{gate}-V_{beam}), along with the switch pull-in voltage 402 (V_{PI}) and the switch pull-out voltage 404 (V_{PO}). V_{PI} is the voltage at which the switch will activate (turn on, in this example), and V_{PO} is the voltage at which the switch will deactivate (turn off, in this example). The example switch in FIG. 4 is depicted in the ON state. As FIG. 4 illustrates, since neither of the V_{gate}-V_{beam} signals approaches the V_{PO} threshold, the switch will not deactivate (i.e., transition to the OFF state).

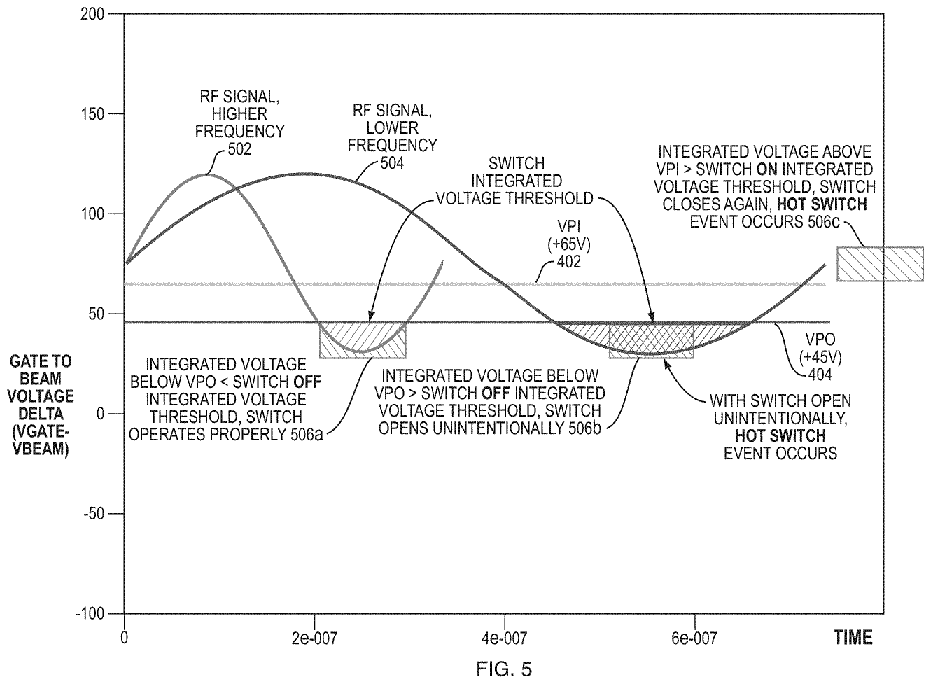

FIG. 5 shows an example of two higher amplitude signals, a lower frequency V_{gate}-V_{beam} signal 504 and a higher frequency V_{gate}-V_{beam} signal 502 are applied between the gate and beam of the switch. In this example, both V_{gate}-V_{beam} signals cross the V_{PO} threshold 404. This crossing puts the switch at risk of de-actuating (for the nominal switch ON case as in this example), or self-actuating (for the nominal switch OFF case). If the area 506a, 506b, associated with these signals below the V_{PO} line, exceeds the “Switch Integrated Voltage Threshold,” the switch will unintentionally turn off. Accordingly, the amount of time the signal is below V_{PO}, and exceeds the mechanical response time (defined by the switch restoring force and its self-mechanical response time to open—i.e., its resonant frequency) determines whether a self-actuation event occurs. In some embodiments, the switch may be configured such that the resonant frequency of its movable element (the switch beam) has a resonant frequency that is less than the minimum frequency of the signal being conveyed through the switch, so as to reduce the likelihood of such self actuation events.

It should be noted that as the frequency of the input signal increases, even large excursions across the VPO threshold may not cause a de-actuation event. This is because at higher frequencies, the excursion may be shorter than the beam's mechanical response time. In other words, before the beam exhibits a substantial mechanical response, the signal voltage reverses back toward the “safe” actuated side of the VPO threshold.

In this example, the excursion of the higher frequency signal 502 below the V_{PO} threshold is small enough that the integrated voltage is less than the switch OFF integrated voltage threshold, so the likelihood of de-actuation is relatively small. The lower frequency signal 504 excursion is large enough that the integrated voltage below V_{PO} is greater than the switch OFF integrated voltage threshold, so in this case the likelihood of de-activation is relatively large. As the amplitude of the signals increases, even the higher frequency signal excursion below the V_{PO} threshold will be large enough to exceed the switch OFF integrated voltage threshold. Further, in the region 506c, the integrated voltage above V_{PI} is greater than the on integrated voltage threshold, so the switch may re-actuate, thereby causing a hot switch event.

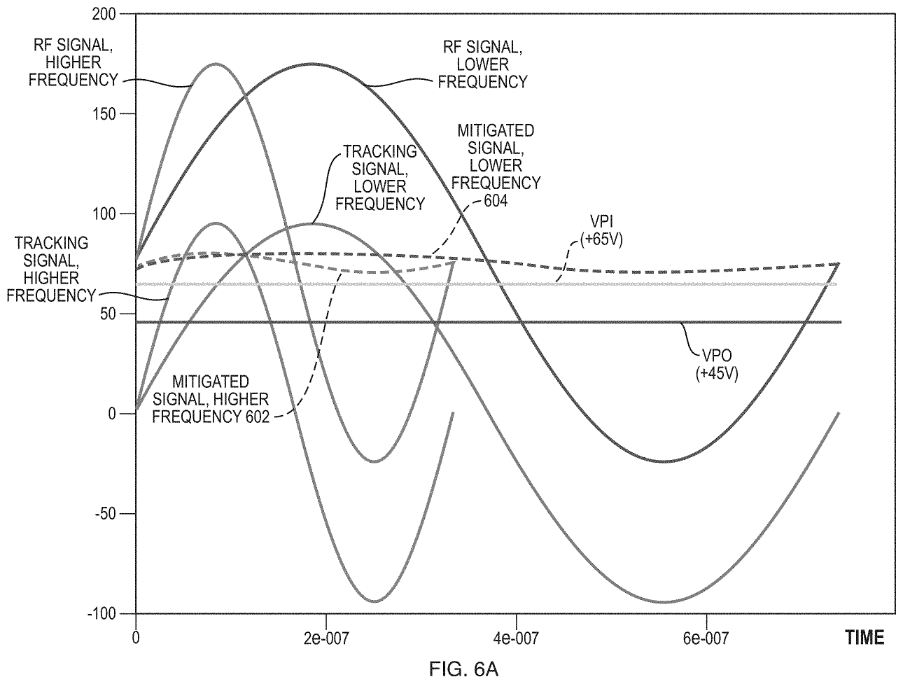

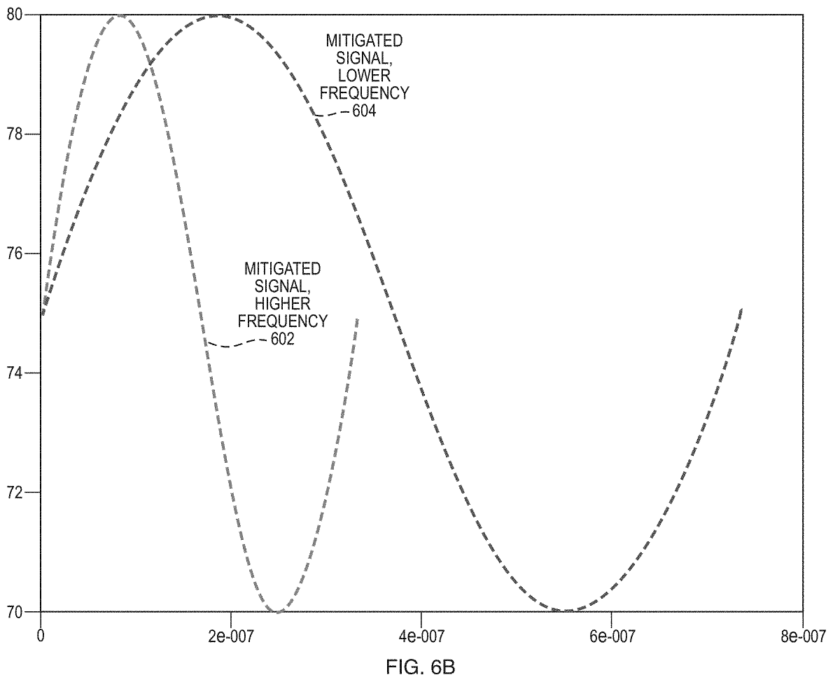

FIG. 6 illustrates the mitigated V_{gate}-V_{beam} signal 602 for the higher frequency input, and the mitigated V_{gate}-V_{beam} signal 604, as a result of implementing at least one of the embodiments described herein. The AC signal applied to the switch beam is used to modulate the switch gate voltage, which reduces the excursions of the V_{gate}-V_{beam} signals, so that the V_{gate}-V_{beam} signals do not approach the VPO threshold. FIG. 6B illustrates a more detailed, reduced amplitude range (70V to 80V) of the signals 602, 604.

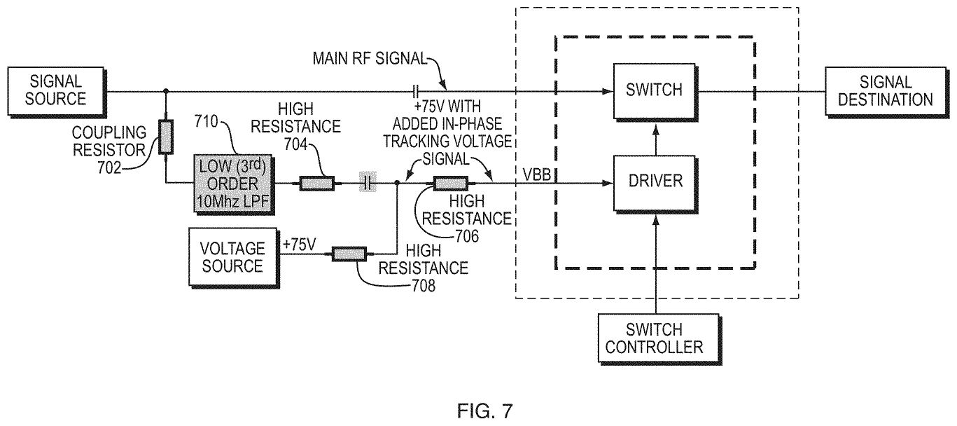

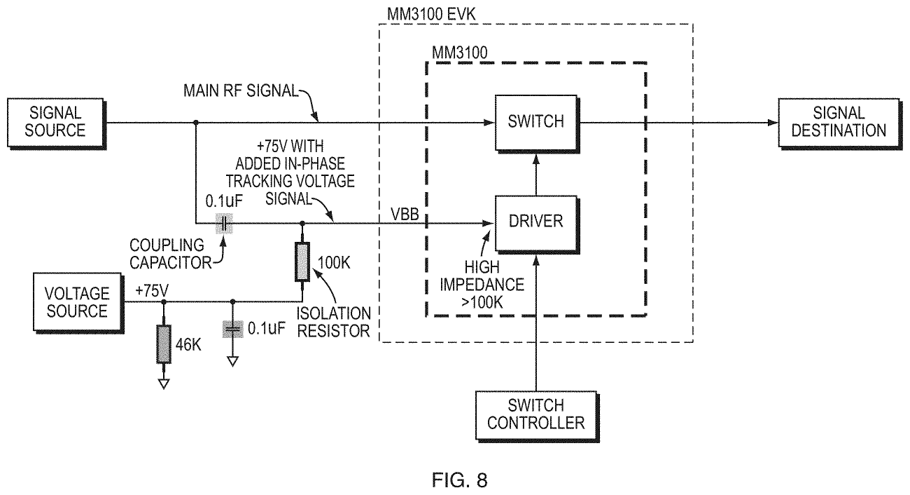

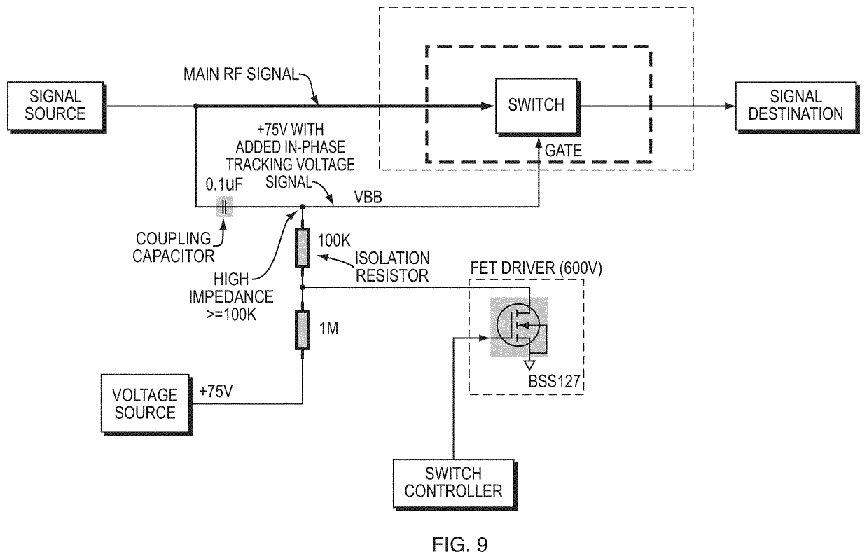

FIGS. 7-9 illustrate alternative example embodiments of a switch self-actuation mitigation system according to the invention. FIG. 7 shows a coupling resistor 702, which in the example embodiment may be about 100KΩ, although other coupling resistor values may be used. Resistors 704, 706 and 708 are labeled as “high resistance,” which in an example embodiment may be about 1MΩ, although other relatively high resistor values may also be used. FIG. 7 also shows a low pass filter (LPF) 710 in the path from the signal source to the driver. For input signals having a frequency above a certain threshold, the excursions of the AC signal below VPO may be insufficient to overcome the inertia and elastic modulus of the beam, so that self-actuation may not occur. The LPF 710 may be used to roll off the contribution of the input AC signal to the actuation signal at higher frequencies. As described elsewhere herein, the amplitude of the input AC signal also factors into whether self-actuation occurs, so the source of the switch self actuation issue may be a function of both frequency and amplitude. Depending on the specific characteristics of the switch and the input signal, a bandpass filter may be more appropriate than a LPF.

In some embodiments of the tracking signal-based switch self-actuation mitigation system, components for coupling the input AC signal to the actuation signal may be on a circuit board or other module separate from the switch and driver. In other embodiments, the coupling components may be arranged on a substrate die within a multi-chip module that also houses the switch and driver. In other embodiments, two or more of the coupling components, the switch and the driver may be integrated on a single substrate.

Certain applications using a MEMS switch may require a pair of switches, connected in series, driven by a common gate. For such a configuration, the coupling point between the two switches should be considered when generating the tracking signal.

While the example embodiments of a switch self-actuation mitigation system based on a generated tracking signal are described with respect to a MEMS switch, it should be understood that the embodiments may alternatively be applied to other types of switch technologies, for example RF silicon on insulator (SOI), GaN, and GaAs, among others.

While example embodiments have been particularly shown and described, it will be understood by those skilled in the art that various changes in form and details may be made therein without departing from the scope of the embodiments encompassed by the appended claims.

What is claimed is:

1. An apparatus for mitigating self-actuation of a switch, comprising:
an input port of the switch configured to receive a radio frequency input signal;
an actuator configured to selectively apply an actuating voltage to the switch, thereby causing a state of the switch to change from one of (i) non-conductive to conductive or (ii) conductive to non-conductive;
a coupler configured to couple at least a portion of the input signal to the actuating voltage; and
an output port that is electrically coupled to the input port when the state of the switch is conductive.

2. The apparatus of claim 1, wherein the switch further comprises a mechanically movable element configured to selectively couple the input port to the output port, and a gate configured to facilitate application of an actuating force to the beam.

3. The apparatus of claim 2, wherein the coupler comprises a capacitor having a first terminal and a second terminal, the first terminal electrically coupled to the input port and the second terminal electrically coupled to the gate.

4. The apparatus of claim 2, wherein the radio frequency input signal is characterized by a minimum frequency that is larger than a resonant frequency of the mechanically movable element.

5. The apparatus of claim 2, wherein the actuator is configured to apply the actuating voltage to the switch through a resistor, a first terminal of the resistor electrically coupled to the actuator, and a second terminal of the resistor electrically coupled to a node, the node further electrically coupled to the gate, and wherein the coupler conveys at least a portion of the input signal to the node.

6. The apparatus of claim 2, wherein the actuator comprises an actuating voltage source, a driver, a switch controller, a first resistor and a second resistor, and wherein:
(i) the actuating voltage source is electrically coupled to a node through the first resistor,
(ii) a first port of the driver is electrically coupled to the node,
(iii) a second port of the driver is electrically coupled to a reference potential,
(iv a control port of the driver is electrically coupled to the switch controller,
(v) the node is electrically coupled to the gate through the second resistor, and
(vi) the driver selectively electrically couples the first port of the driver to the second port of the driver in response to a switch control signal from the switch controller applied to the control port of the driver.

7. The apparatus of claim 2, wherein the mechanically movable element comprises two or more movable segments, each of which is configured to selectively couple the input port to a respective output port.

8. The apparatus of claim 1, wherein the switch further comprises:
a first switch segment comprising a first output port, a first movable mechanical element configured to selectively electrically couple the first input port to the first output port, and a first gate configured to facilitate application of the actuating force to the first movable mechanical element;
a second switch segment comprising a second output port, a second movable mechanical element configured to selectively electrically couple the second input port to the second output port, and a second gate configured to facilitate application of the actuating force to the second movable mechanical element;
wherein the first gate is electrically coupled to the second gate, and the first output port is electrically coupled to the second input port.

9. The apparatus of claim 8, wherein the coupler comprises a capacitor having a first terminal and a second terminal, the first terminal is electrically coupled to the first output port and the second input port, and the second terminal is electrically coupled to the first gate and the second gate.

10. The apparatus of claim 2, wherein the actuator comprises an actuating voltage source, a driver, a switch controller, a first resistor and a second resistor, and wherein:
(i) the actuating voltage source is electrically coupled to a node through the first resistor,
(ii) a first port of the driver is electrically coupled to the node through a second resistor,
(iii) the first port of the driver is electrically coupled to the gate,
(iv) a control port of the driver is electrically coupled to the switch controller,
(v) the driver selectively electrically couples the first port of the driver to the second port of the driver in response to a switch control signal from the switch controller applied to the control port of the driver, and
(vi) the coupler electrically couples the input signal to the node.

11. The apparatus of claim 10, wherein the coupler comprises a filter.

12. The apparatus of claim 11, wherein the filter is a low pass filter.

13. A method of mitigating self-actuation of a switch, comprising:
coupling an input signal from a signal source to an input port of the switch; and
combining at least a portion of the input signal with a switch actuating voltage, thereby forming a tracking signal configured to facilitate a switch actuation force.

14. The method of claim 13, wherein the switch further comprises (i) a mechanically movable element configured to selectively couple the input port of the switch to an output port of the switch, and (ii) a gate configured to apply an actuating force to the mechanically movable element, and wherein combining at least a portion of the input signal with the switch actuating voltage further comprises at least partially coupling the input signal to the gate.

15. The method of claim 14, wherein at least partially coupling the input signal to the gate further comprises disposing a capacitor between the input port of the switch and the gate.

16. The method of claim 14, further comprising applying, by an actuator, an actuating voltage to the gate.

17. The method of claim 16, wherein applying an actuating voltage to the gate further comprises selectively coupling a node to a ground potential in response to a switch control signal, wherein:
(a) the node is electrically coupled to the gate through a first resistor,
(b) the node is electrically coupled to an actuating voltage source through a second resistor.

18. An apparatus for mitigating self-actuation events, comprising:
a switch comprising an input port, an output port, a mechanically movable element configured to selectively couple the input port to the output port, and a gate configured to facilitate application of an actuating force to the mechanically movable element, the input port configured to receive an input signal;
an actuator configured to selectively apply an actuating voltage to the switch, thereby causing a state of the switch to change from one of (i) non-conductive to conductive or (ii) conductive to non-conductive; and
an output port that is electrically coupled to the input port when the state of the switch is conductive.

19. The apparatus of claim 18, wherein the actuator further comprises a first resistor and a second resistor, and wherein:
(i) the actuating voltage source is coupled to a node through the first resistor,
(ii) a first port of the driver is coupled to the node,
(iii) a second port of the driver is coupled to a reference potential,
(iv a control port of the driver is coupled to the switch controller,
(v) the node is coupled to the gate through the second resistor, and
(vi) the driver selectively couples the first port of the driver to the second port of the driver in response to a switch control signal from the switch controller applied to the control port of the driver.

20. The apparatus of claim 18, wherein the coupler comprises a capacitor having a first terminal and a second terminal, the first terminal electrically coupled to the input port and the second terminal electrically coupled to the gate.

21. The apparatus of claim 18, wherein the beam comprises two or more beam segments, each of which is configured to selectively couple the input port to a respective output port.

22. The apparatus of claim 18, wherein the coupler comprises a bandpass filter.
